(19) United States
(12) Patent Application Publication
(10) Pub. No.: US 2015/0182966 A1
(43) Pub. Date: Jul. 2, 2015

(54) FIELD DEPLOYABLE SMALL FORMAT FAST FIRST RESULT MICROFLUIDIC SYSTEM

(71) Applicant: Canon U.S. Life Sciences, Inc., Rockville, MD (US)

(72) Inventors: Johnathan S. COURSEY, Rockville, MD (US); Hongye LIANG, Clarksville, MD (US)

(73) Assignee: Canon U.S. Life Sciences, Inc., Rockville, MD (US)

(21) Appl. No.: 14/586,321

(22) Filed: Dec. 30, 2014

Related U.S. Application Data
(60) Provisional application No. 61/922,793, filed on Dec. 31, 2013.

(51) Int. Cl. B01L 7/00

(52) U.S. Cl. CPC B01L 7/52

(57) ABSTRACT

A field-deployable small format microfluidic system includes simplified, low-cost system control elements, optics, fluid control, and thermal control. An embodiment of a microfluidic chip includes a first plate having reagent wells and pneumatic ports formed therein, a second plate with reaction wells and microfluidic channels connecting each reaction well with one reagent well and one pneumatic port formed therein, and a printed circuit board with heater elements, a temperature sensor, and thermal vias providing thermal transfer through the PCB. In one embodiment, the reaction wells, pneumatic ports, reaction wells, and thermal vias are formed symmetrically with respect to a geometric center of the microfluidic chip to promote thermal uniformity across the reaction wells.

### CROSS REFERENCE OF RELATED APPLICATION

This application claims the benefit under 35 U.S.C. §119(e) of the filing date of provisional patent application Ser. No. 61/922,793 filed Dec. 31, 2013, the entire disclosure of which is incorporated herein by reference.

### FIELD OF THE DISCLOSURE

This disclosure relates to microfluidic systems and, more specifically, to microfluidic systems that are simple in construction and low cost.

### BACKGROUND

The detection of nucleic acids is central to medicine, forensic science, industrial processing, crop and animal breeding, and many other fields. The ability to detect disease conditions (e.g., cancer), infectious organisms (e.g., HIV), genetic lineage, genetic markers, and the like, is ubiquitous technology for disease diagnosis and prognosis, marker assisted selection, correct identification of crime scene features, the ability to propagate industrial organisms and many other techniques. Determination of the integrity of a nucleic acid of interest can be relevant to the pathology of an infection or cancer. One of the most powerful and basic technologies to detect small quantities of nucleic acids is to replicate some or all of a nucleic acid sequence many times, and then analyze the amplification products. Polymerase Chain Reaction (“PCR”) is perhaps the most well-known of a number of different amplification techniques.

More recently, a number of high throughput approaches to performing PCR and other amplification reactions have been developed, for example, involving amplification reactions in microfluidic devices, as well as methods for detecting and analyzing amplified nucleic acids in or on the devices. Microfluidic chips are being developed for “lab-on-a-chip” devices to perform in-vitro diagnostic testing. A general trend in in-vitro diagnostic microfluidic chips is to make them smaller to conserve sample volumes, material cost, biohazard waste volume, and to reduce thermal mass of the chip for faster PCR cycling. Another trend has been a drive in real-time PCR development towards portability, sensitivity, and rapid response capabilities. Certain portable commercial systems are available as field deployable machines together with a range of freeze-dried PCR reagents and specific detection kits. Such systems provide “push button” software which permits use by personnel with minimal training.

Many such devices have been developed, but common problems with currently-existing field-deployable units are high cost/complexity disposables that can only be made in the lab, slow thermal cycling in plastic devices, and a difficult/unreliable interface between the chip and the world.

One relevant development has been the use of printed circuit board (PCB) fabrication technology for producing microfluidic devices. Specifically, microfluidic devices maybe fabricated onto PCB for integrated on-chip electronic control and cost reduction. PCBs can be manufactured in large quantities at high precision and low cost, readily integrated with functional components, making this an attractive platform for microfluidics.

As mentioned, field deployable units, including those using microfluidic systems are commonly hindered by problems including high cost and complexity of disposables, difficulties achieving the required thermal cycling, and difficult/unreliable interfaces between the microfluidic chip and the world. The manufacturing of modular microfluidic systems may be a useful in overcoming these issues, as it would allow for a modular microfluidic packaging system which can incorporate separately developed microfluidic components in an integrated device. Accordingly, a need exists for a field-deployable microfluidic system that provides fast accurate results while reducing complexity and costs of such system. Alternatively or in addition, a microfluidic system for performing biological reactions including PCR that combines benefits of PCB technology with a modular systems approach may be needed.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof.

Aspects of the disclosure are embodied in a device for performing a microfluidic procedure. The device comprises a first plate, a second plate, and a printed circuit board (PCB), with the second plate disposed between the first plate and the PCB. The first plate has a plurality of reagent wells and pneumatic ports formed therein. The second plate has a first surface secured to a surface of the first plate and includes a plurality of reaction wells and a plurality of microchannels formed therein. The microchannels are configured to fluidly connect each of the reaction wells to one of the reagent wells and to one of the pneumatic ports. The PCB has a first surface secured to a second surface of the second plate opposite the first surface of the second plate and comprises: one or more heater elements secured to a second surface of the PCB opposite the first surface, one or more temperature sensors secured to the second surface of the PCB, one or more thermally conductive vias associated with the heater element(s) and configured to provide a thermal coupling between the heater element(s) and the reaction wells, and one or more thermally conductive vias associated with the temperature sensor(s) and configured to provide a thermal coupling between the temperature sensor(s) and the reaction wells.

According to further aspects, a plurality of heater elements are arranged in a pattern surrounding the reaction wells.

According to further aspects, the temperature sensor(s) is(are) mounted in a via landing beneath the reaction wells.

According to further aspects, at least one of the first and second plates is made from plastic.

According to further aspects, the plastic comprises cyclic olefin copolymer.

According to further aspects, the pneumatic ports are arranged in a pattern circumscribing a perimeter of the first plate, and the reagent wells are arranged in a pattern circumscribing a geometric center of the first plate at a location inwardly of the pneumatic ports.

According to further aspects, the first plate, the second plate, and the PCB are rectangular or square.

According to further aspects, the first plate, the second plate, and the PCB are rectangular or square and have the same dimensions.

According to further aspects, the first plate includes an opening formed therein at a location corresponding to a location of the reaction wells in the second plate.

According to further aspects, the thermally conductive vias are formed from copper.

According to further aspects, the reagent wells and the pneumatic ports are arranged symmetrically with respect to a geometric center of the first plate.

According to further aspects, the device comprises a pierceable foil covering open top ends of the reagent wells.

According to further aspects, the device comprises a liquid impervious, gas porous mesh covering the pneumatic ports.

According to further aspects, each heater element comprises a resistor mounted on the second surface of the PCB.

According to further aspects, the device comprises a heater conductor pad electrically connected to the heater elements and located on the second surface of the PCB and configured to make electrically conductive contact with a contact element in a processing instrument.

According to further aspects, the sensor element comprises a resistance temperature detector mounted on the second surface of the PCB.

According to further aspects, the device further comprises a sensor conductor pad electrically connected to the sensor element and located on the second surface of the PCB and configured to make electrically conductive contact with a contact element in a processing instrument.

Aspects of the disclosure are embodied in a device for performing a nucleic acid amplification procedure thereon, comprising a substrate, a microchannel plate, and at least one temperature sensor. The substrate has a plurality of reagent wells and pneumatic ports formed therein. The microchannel plate has a first surface secured to a surface of the substrate and includes a plurality of reaction wells, a plurality of first microchannels, and a plurality of second microchannels formed therein. Each first microchannel is configured to fluidly connect each of the reaction wells to one of the reagent wells and each second microchannel is configured to fluidly connect each of the reaction wells to one of the pneumatic ports. The temperature sensor is disposed within at least one reaction well.

According to further aspects, at least one of the substrate and the microchannel plate is made from plastic.

According to further aspects, the plastic comprises cyclic olefin copolymer.

According to further aspects, the device further comprises a pierceable foil covering open top ends of the reagent wells.

According to further aspects, the device further comprises a liquid impervious, gas porous mesh covering the pneumatic ports.

Aspects of the disclosure are embodied in a method of holding a liquid within a fixed location within a microfluidic device comprising a plurality of sample wells, a plurality of pneumatic ports, each pneumatic port being fluidically connected to one of the input wells, and liquid impervious, gas porous membranes covering the pneumatic ports. The method comprises applying a continuous negative pressure at the pneumatic ports to draw liquid from the input wells to the membrane covering the pneumatic ports, wherein the membrane permits the negative pressure to be applied to the liquid but prevents the liquid from exiting the pneumatic ports through the membrane.

According to further aspects, the microfluidic device further includes a pierceable foil covering the sample wells, and the method further comprises piercing the foil covering at least one of the reagent wells and dispensing liquid sample material into the reagent well through an opening pierced in the foil covering the well.

According to further aspects, the method further comprises drawing the liquid to the membrane covering the pneumatic ports through a microfluidic channel and determining if a microfluidic channel has been filled by measuring fluorescent emission from a portion of the channel.

Aspects of the disclosure are embodied in a method for adding fluid material to a microfluidic device comprising a plurality of reagent wells covered with a pierceable foil and a plurality of pneumatic ports, each pneumatic port being fluidically connected to one of said input wells. The method comprises piercing the foil covering at least one of the reagent wells, dispensing liquid sample material into the reagent well through an opening pierced in the foil covering the well, covering each opening pierced in the foil with a liquid impervious, gas porous membrane, applying a pressure differential at the pneumatic ports to draw liquid from the input well into one or more microfluidic channels connecting the input wells with the pneumatic ports, and determining if a microfluidic channel has been filled by measuring fluorescent emission from a portion of the channel.

According to further aspects, the method further comprises mixing the fluid dispensed into the input wells by shaking or rotating the microfluidic device or by pumping liquid back and forth through the microfluidic channels.

According to further aspects, the method further comprises performing a nucleic acid amplification process after drawing fluid from the input wells to the microfluidic channels.

According to further aspects, the method further comprises performing a thermal melt analysis on a product of the nucleic acid amplification.

According to further aspects, the method further comprises reversing the pressure differential applied at the pneumatic ports to push fluid from the microfluidic channel back to the input well.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a schematic view of an embodiment of a field deployable small format microfluidic system.

FIG. 2 is a partially exploded perspective view of an embodiment of a microfluidic chip.

FIG. 3 is a top plan view of the microfluidic chip of FIG. 2.

FIG. 4 is a partial perspective view of an alternate embodiment of a microfluidic chip.

FIG. 5 is a partial perspective view of a further alternate embodiment of a microfluidic chip.

FIG. 6 is a perspective view of a still further alternate embodiment of a microfluidic chip.

FIG. 7 is a perspective view of the embodiment of FIG. 6 showing three separate plates that form the microfluidic chip.

FIG. 8 is a bottom perspective view of a middle plate of the microfluidic chip of FIGS. 6 and 7.

FIG. 9 is a top perspective view of the middle plate of the microfluidic chip of FIGS. 6 and 7.

FIG. 10 is a bottom plan view of the middle plate of the microfluidic chip of FIGS. 6 and 7.

FIG. 11 is a bottom plan view of a printed circuit board (“PCB”) comprising the third plate of the microfluidic chip of FIGS. 6 and 7.

FIG. 12 is a top plan view of the PCB.

FIG. 13 is a partial transverse cross-section of the PCB and the middle plate of the microfluidic chip of FIGS. 6 and 7.

### DETAILED DESCRIPTION OF PREFERRED EMBODIMENTS

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use relative spatial and/or orientation terms in describing the position and/or orientation of a component, apparatus, location, feature, or a portion thereof. Unless specifically stated, or otherwise dictated by the context of the description, such terms, including, without limitation, top, bottom, above, below, under, on top of, upper, lower, left of, right of, in front of, behind, next to, adjacent, between, horizontal, vertical, diagonal, longitudinal, transverse, radial, axial, etc., are used for convenience in referring to such component, apparatus, location, feature, or a portion thereof in the drawings and are not intended to be limiting.

Furthermore, unless otherwise stated, any specific dimensions mentioned in this description are merely representative of an exemplary implementation of a device embodying aspects of the disclosure and are not intended to be limiting.

System Overview

This disclosure describes a modular microfluidic processing system configured to run small format microfluidic devices for very low cost and fast time to result. There are very few components in this system. The system may include various functional options that span a range of costs. Like the processing instrument, the microfluidic devices (e.g., disposable microfluidic chips) may range in cost and complexity. The modular format of this system allows for the interchangeability of various components. For instance, different formats of disposable microfluidic chips could be interchanged with various optics systems or processing devices, dependent on the needs of the user.

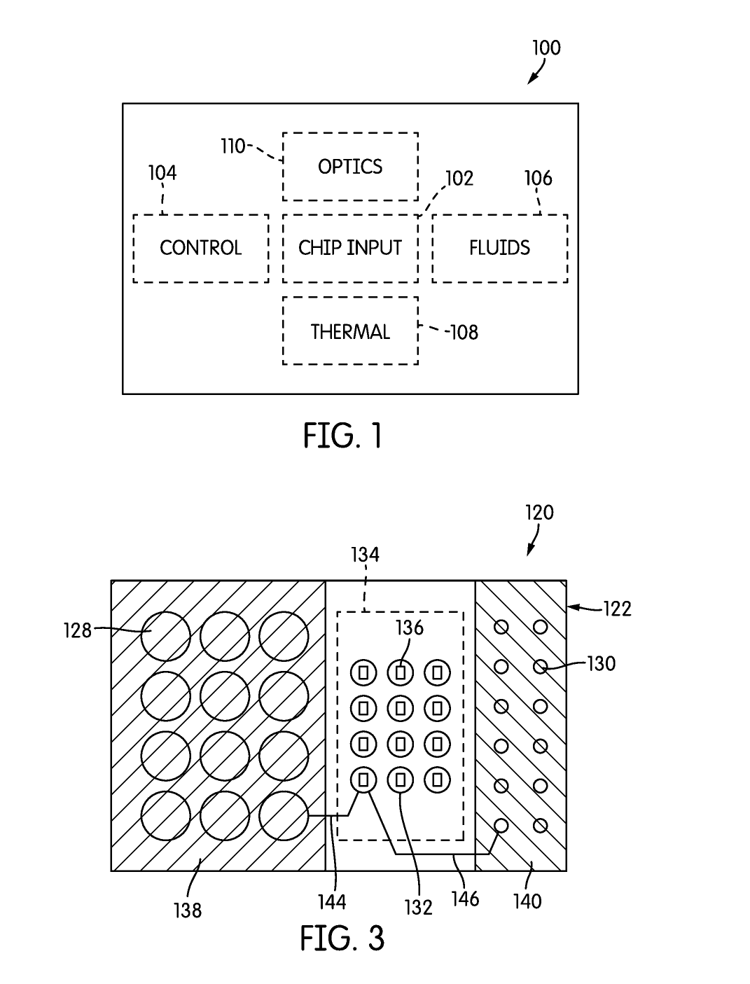

FIG. 1 is a block diagram illustrating subsystems of a field deployable microfluidic system 100 that can be configured to embody various aspects of the disclosure. FIG. 1 illustrates subsystems that may be implemented in various combinations to implement a system having the characteristics and functionality preferred for an embodiment. The system shown in FIG. 1 need not necessarily be implemented in its entirety and not all subsystems of the system shown in FIG. 1 need necessarily be implemented in a system having the characteristics and functionality preferred for an embodiment.

System 100 shown in FIG. 1 may include a chip input 102 for receiving a microfluidic device, e.g., a microfluidic chip, such as will be described below. The chip input 102 may comprising a slot or chamber formed in a chassis of an instrument embodying the system and configured to receive and process a microfluidic chip.

Control subsystem 104 may comprise a programmed computer or other microprocessor, e.g., incorporated on a printed circuit board (PCB). Because of the relative simplicity of the microfluidic chip, a field programmable gate array (FPGA) or applications specific integrated circuit (ASIC) or similar small format processor may be sufficient to control the microfluidic chip. At least some aspects of the control logic may be incorporated in to a PCB that is part of the microfluidic chip.

As generally and specifically described throughout this disclosure, aspects of the system are implemented via control and computing hardware components, user-created software, data input components, and data output components. Hardware components include computing and control modules (e.g., system controller(s)), such as FPGAs, ASICs, microprocessors, and/or computers, configured to effect computational and/or control steps by receiving one or more input values, executing one or more algorithms stored on non-transitory machine-readable media (e.g., software embodied as FPGAs or ASICs,) that provide instruction for manipulating or otherwise acting on the input values, and output one or more output values. Such outputs may be displayed or otherwise indicated to a user for providing information to the user, for example information as to the status of the instrument, a process being performed thereby, or results of a process, or such outputs may comprise inputs to other processes and/or control algorithms. Data input components comprise elements by which data is input for use by the control and computing hardware components. Such data inputs may comprise sensors, as well as manual input elements, such as graphic user interfaces, keyboards, touch screens, microphones, switches, manually-operated scanners, voice-activated input, etc. Data output components may comprise hard drives or other storage media, graphic user interfaces, monitors, printers, indicator lights, or audible signal elements (e.g., buzzer, horn, bell, etc.).

Software comprises instructions stored on non-transitory computer-readable media which, when executed by the control and computing hardware, cause the control and computing hardware to perform one or more automated or semi-automated processes.

In order to achieve PCR for a DNA sample within the microfluidic chip, the temperature of the sample must be cycled, as is well known in the art. Other amplification processes may be isothermal and require the maintenance of a steady temperature profile. Accordingly, in some embodiments, system 100 includes a thermal subsystem 108. Thermal subsystem 108 may include one or more temperature sensors, a heater/cooler (which may comprise one or more heater and/or cooler devices), and a temperature controller, which may comprise a programmed computer or other microprocessor which sends control signals to the heater/cooler and/or receives signals from the temperature sensor. In some embodiments, a thermal subsystem 108 is interfaced with or a part of the control subsystem 104 to control the temperature of the samples within the microfluidic chip. In various embodiments, at least some elements of the thermal subsystem 108, such as heating/cooling elements and/or temperature sensors, may incorporated into the microfluidic chip, such as on a PCB that is part of the microfluidic chip and/or within reaction chambers within the microfluidic chip.

Heat could be provided by a heater that is external to the microfluidic device or a peltier device that is part of a processing instrument. Alternatively, or in addition, the heat source could be part of the microfluidic device. Temperature sensing can be by sensors that are external to the microfluidic device or with sensors embedded on a PCB that is bonded to the device.

To monitor the PCR process and/or a melting process that occur in reaction wells within the microfluidic chip—for example by detecting an optic emission signal from the contents of the reaction well—system 100 may include an optics subsystem 110. Optics subsystem 110 may include an excitation source, such as a light emitting diode or other optic signal source, an image capturing device, such as a camera, a photodiode, or a photomultiplier tube, a controller, and image storage media. The controller of the optics subsystem 110 may be part of the control subsystem 104.

The optics subsystem 110 may also be configured to monitor flow of sample through microfluidic channels of a microfluidic device. In one embodiment, the flow monitoring system can be a fluorescent dye imaging and tracking system, e.g., as illustrated in U.S. Pat. No. 7,629,124. According to one embodiment, channels or portions of channels or the reaction wells can be excited by an excitation source and light fluoresced from the sample can be detected by a detection device to confirm the presence or absence of the sample from the channel and/or reaction well.

To simplify a field-deployable instrument and keep costs down, the instrument may have no robots, pipettors, well plate, sophisticated flow control, syringe pumps, vent wells, or bulky detection/imaging system (e.g., no camera). The fluid system may have only one pump that can be selectively connected to some or all pneumatic ports of a microfluidic chip.

In various embodiments, the microfluidic chip disclosed herein has fewer parts than conventional microfluidic devices, and much less costly components are required for the system processor, i.e., the control processor 104. In various embodiments, it would be possible to control the system with a field programmable gate array (FPGA)/application specific integrated circuit (ASIC) or similar small format processor.

The field deployable system as disclosed herein could be used for point of care, biohazard, infectious disease, academics (i.e., teaching), and research. It is contemplated that sample to answer can be achieved in less than 30 minutes and further that the product can be easily extracted from the microfluidic chip after processing for subsequent analysis by other processes (e.g., sequencing).

Microfluidic Chip

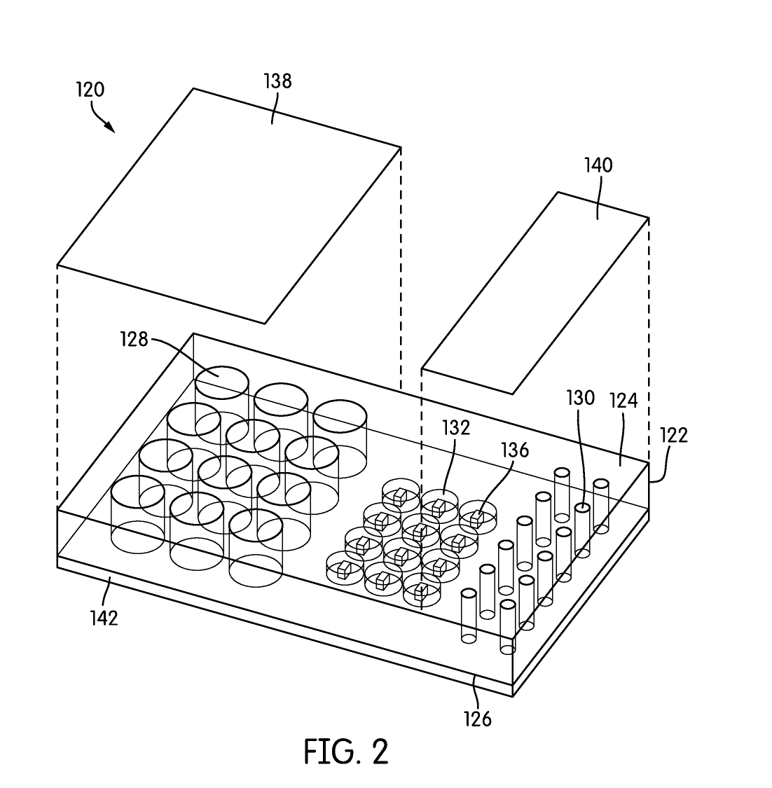

A first embodiment of a microfluidic chip for use in a field deployable small format microfluidic system is represented by reference number 120 in FIGS. 2 and 3. The microfluidic chip 120 includes a substrate 122 with a first, or top, surface 124 and a second, or bottom, surface 126 opposite the first surface 124. One or more of reagent wells 128 are formed in the substrate 122 and, in various embodiments, may comprise cylindrical through-holes extending from the top surface 124 to the bottom surface 126. The illustrated embodiment includes twelve (12) reagent wells 128, although this is not intended to be limiting, and the microfluidic chip 120 may include fewer than twelve (12) reagent wells 128 or more than twelve (12) reagent wells 128.

Because, as will be described below, sample materials to be processed on the microfluidic chip 120 are dispensed into the reagent wells 128, the reagent wells 128 may also be referred to as sample wells or sample input wells.

A plurality of pneumatic ports 130 are formed in the substrate 128 and may comprise through holes extending from the top surface 124 to the bottom surface 126. The pneumatic ports 130 are configured to cooperate with a pump or vacuum port within an instrument configured to process the microfluidic chip 120. In various embodiments, the number of pneumatic ports 130 is equal to the number of reagent wells 128, e.g., in the illustrated embodiment, twelve (12) pneumatic ports 130 corresponding to twelve (12) reagent wells 128.

The microfluidic chip 120 further includes a reaction zone 134 which, in various embodiments, comprises a plurality of reaction wells 132 formed in the substrate 122. In various embodiments, the reaction wells 132 may comprise blind openings having a cylindrical shape and extending from the bottom surface 126 partially into the thickness of the substrate 122. In various non-limiting embodiments, reaction wells 132 may have a capacity of about 4 μL. Making the dimensions of the reaction wells 132 smaller improves temperature uniformity.

In various embodiments, temperature sensors 136 may be provided in each of the reaction wells 132 or may be embedded within the substrate 122 adjacent to each of one or more of the reaction wells 132. Sensors 136 may comprise, for example, surface mount technology (“SMT”) sensors, such as thermistors or resistance temperature detectors (“RTDs”), for factory calibrated temperature sensing. In various embodiments, the sensors (thermistors or RTDs) can be passivated with acrylic, parylene, silicone, epoxy, etc.

The reagent wells 128 may be pre-filled with suitable reagents and other materials required for an assay to be performed on the microfluidic chip, such as amplification reagents, primers, buffers, probes, etc., or combinations of two or more thereof. A pierceable foil 138 is provided over the reagent wells 128, which may be prefilled with one or more suitable reagents or other materials prior to the application of the pierceable foil 138. A suitable pierceable foil may comprise aluminum foil that is heat-sealed to the substrate 122 or is attached to the substrate 122 with a pressure sensitive adhesive. Similar foils or other pierceable layers may alternatively be used.

A liquid impervious, gas porous mesh 140 may be provided on the top surface 124 so as to cover the open upper ends of the pneumatic ports 130. The mesh 140 is preferably configured to retard or prevent liquid leakage from the ports 130 but is gas porous so as to permit the application of a pressured differential to the microfluidic chip through each of the pneumatic ports 130. A suitable mesh may comprise a hydrophobic air permeable membrane made of a hydrophobic material or coating such as polyvinylidene fluoride (PVDF), polyproplyene (PP), polycarbonate (PC), polytetrafluoroethylene (PTFE), polyethylene terephthalate (PET), etc., that allows gas to vent from aqueous materials and is low in extractables. Pore sizes may range from 10 nm to 10 μm, preferably from 30 nm to 220 μm, and most preferably 100 nm. A suitable membrane is the VVHP04700 Durapore Membrane Filter, available from EMD Millipore.

A microchannel plate 142 is secured to and covers at least a portion of the bottom surface 126 of the substrate 122. The microchannel plate 142 encloses the lower ends of each of the reagent wells 128, pneumatic ports 130, and reaction wells 132. As shown in FIG. 3, looking at features of the microchannel plate through the substrate 122, the microchannel plate includes a set of first microchannels 144 connecting each of the reagent wells 128 to one of the reaction wells 132 and a second set of microchannels 146 connecting each of the reaction wells 132 to one of the pneumatic ports 130. Because of the direct fluid route from the reagent wells 128 to the reaction wells 132 to the pneumatic ports 130 via first microchannels 144 and second microchannels 146, the processing instrument can prime the fluid flow through microfluidic chip 120 simply by applying a pressure differential at the pneumatic port 130.

For simplicity, FIG. 3 shows only one first microchannel 144 and one second microchannel 146, although, in various embodiments, a first microchannel and a second microchannel will be associated with each reaction well 132 connecting each reaction well 132 to one of the reagent wells 128 and one of the pneumatic ports 130, respectively. In one embodiment, the microchannels are formed as microgrooves on a top surface of the microchannel plate 162 (i.e., the surface of the microchannel plate 162 that contacts the bottom surface 126 of the substrate 122).

Although not shown in FIGS. 2 and 3, the microfluidic chip 120 may also include a printed circuit board (PCB) having heater elements and other electrical components, such as electrical connectors for providing a connection between the chip 120 and the processing instrument. In an alternate embodiment, temperature sensors may be provided in the PCB in addition to or instead of the temperature sensors 136 provided in or adjacent to each of the reaction wells 132.

In various embodiments, the substrate 122 is made from cyclic olefin copolymer, cyclic olefin polymer, polycarbonate, or similar material. In one embodiment, the substrate is made of a transparent material so that optical measurements, such as fluorescent emission measurements made during a PCR and/or a thermal melt process, can be made of a reaction occurring within each of the reaction wells 132.

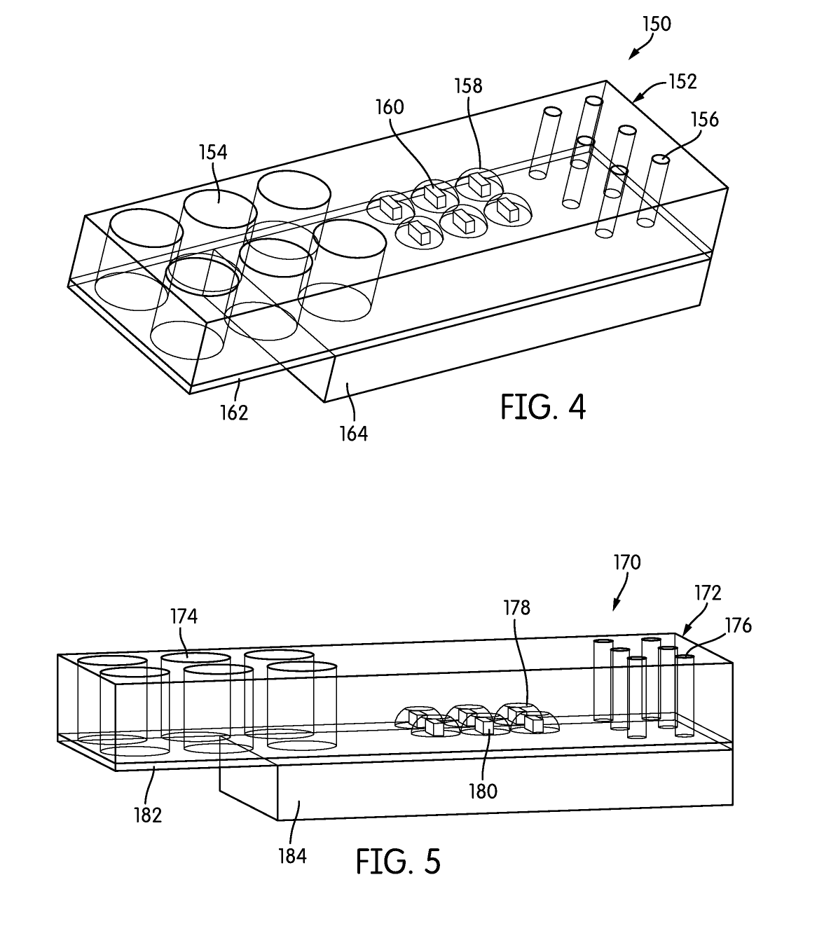

A second embodiment of a microfluidic chip is indicated by reference number 150 in FIG. 4. FIG. 4 is a perspective view of one lateral half of the chip, with the chip cut lengthwise through the middle of the chip. Microfluidic chip 150 includes a substrate 152 with a plurality of reagent wells 154, a plurality of pneumatic ports 156, and a plurality of reaction wells 158 formed in the substrate 152. In various embodiments, the numbers of reagent wells 154, pneumatic ports 156, and reaction wells 158 are equal. FIG. 4 shows only one half of a microfluidic chip having a configuration similar to that of the chip shown in FIGS. 2 and 3, and thus only six (6) reagent wells 154, pneumatic ports 156, and reagent wells 158 are shown in FIG. 4.

Reaction wells 158 have a hemispherical shape, as opposed to the cylindrical shape of the reaction wells 132 of the microfluidic chip 120 shown in FIGS. 2 and 3. The hemispherical shape of the reaction wells 158 improves the thermal uniformity of the sample.

In various embodiments, a temperature sensor 160 is disposed within or embedded adjacent to each of one or more of the reaction wells 158.

In various embodiments, the substrate 152 is made from cyclic olefin copolymer, cyclic olefin polymer, polycarbonate, or similar material.

In one embodiment, the substrate is made of a transparent material so that optical measurements, such as fluorescent emission measurements made during a PCR and/or a thermal melt process, can be made of a reaction occurring within each of the reaction wells 158.

Microfluidic chip 150 further includes a microchannel plate 162 secured to a bottom surface of the substrate 152 and has formed therein first and second microchannels (not shown) for connecting each reagent well 154 and each pneumatic port 156 to one of the reaction wells 158.

In various embodiments, microfluidic chip 150 may also include a printed circuit board (PCB) 164 having heater elements and other electrical components, such as electrical connectors for providing a connection between the chip 150 and the processing instrument. In an alternate embodiment, temperature sensors may be provided in the PCB 164 in addition to or instead of the temperature sensors 160 provided in or adjacent to each of the reaction wells 158.

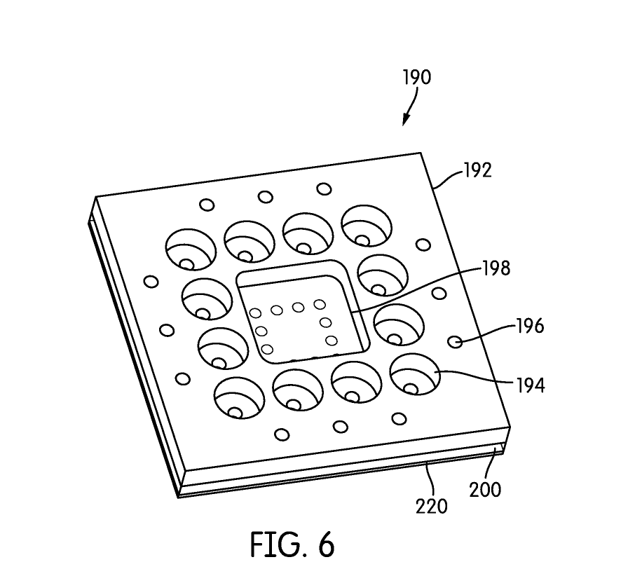

A third embodiment of a microfluidic chip is indicated by reference number 170 in FIG. 5. FIG. 5 is a perspective view of one lateral half of the chip, with the chip cut lengthwise through the middle of the chip. Microfluidic chip 150 includes a substrate 172 with a plurality of reagent wells 174, a plurality of pneumatic ports 176, and a plurality of reaction wells 178 formed in the substrate 172. In various embodiments, the numbers of reagent wells 174, pneumatic ports 176, and reaction wells 178 are equal. FIG. 5 shows only one half of a microfluidic chip having a configuration similar to that of the chip shown in FIGS. 2 and 3, and thus only six (6) reagent wells 174, pneumatic ports 176, and reagent wells 178 are shown in FIG. 5.

Reaction wells 178 have a flattened hemispherical shape, as opposed to the cylindrical shape of the reaction wells 132 of the microfluidic chip 120 shown in FIGS. 2 and 3 or the hemispherical shape of the reaction wells 158 of the microfluidic chip 150 shown in FIG. 4. The flattened hemispherical shape provides even better thermal uniformity than a hemispherical shape.

In various embodiments, a temperature sensor 180 is disposed within or embedded adjacent to each of one or more of the reaction wells 178.

In various embodiments, the substrate 172 is made from cyclic olefin copolymer, cyclic olefin polymer, polycarbonate, or similar material. In one embodiment, the substrate is made of a transparent material so that optical measurements, such as fluorescent emission measurements made during a PCR and/or a thermal melt process, can be made of a reaction occurring within each of the reaction wells 178.

Microfluidic chip 170 further includes a microchannel plate 182 secured to a bottom surface of the substrate 172 and has formed therein first and second microchannels (not shown) for connecting each reagent well 174 and each pneumatic port 176 to one of the reaction wells 178.

In various embodiments, microfluidic chip 170 may also include a printed circuit board (PCB) 184 having heater elements and other electrical components, such as electrical connectors for providing a connection between the chip 170 and the processing instrument. In an alternate embodiment, temperature sensors may be provided in the PCB 184 in addition to or instead of the temperature sensors 180 provided in or adjacent to each of the reaction wells 178.

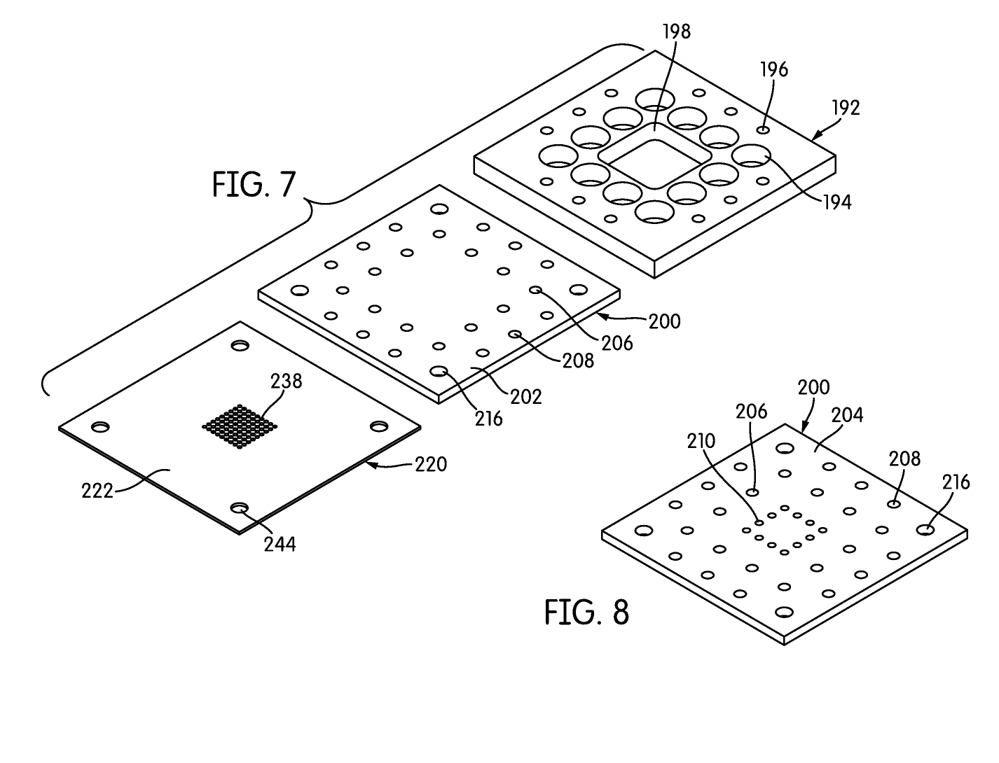

A fourth embodiment of a microfluidic chip is represented by reference number 190 in FIG. 6. Referring to FIGS. 6 and 7, in various embodiments, the microfluidic chip 190 is formed from three separate components, including a first plate, or well plate, 192, a printed circuit board 220, and a second plate, or microchannel plate, 200 sandwiched between a well plate 192 and the PCB 220. In an exemplary embodiment, microfluidic chip 190 has dimensions of 25 mm×25 mm×3.5 mm.

The well plate 192 includes a plurality of reagent wells 194 comprising through-holes extending through the thickness of the well plate 192. In an exemplary embodiment, the reagent wells have an outside diameter of 3.7 mm and are 2 mm deep with a volume of 21.5 μL. In the illustrated embodiment, well plate 192 includes twelve (12) reagent wells 194 arranged in a symmetrical, square pattern surrounding or circumscribing a geometric center of the well plate 192. In other embodiments, a well plate may comprise more or less than twelve (12) reagent wells, and the reagent wells may be arranged in other, preferably biaxially symmetric shapes, such as a circle or a biaxially symmetric polygon.

Reagent wells 194 may be covered, for example, with a pierceable foil.

Well plate 192 further includes a plurality of pneumatic ports 196, which may comprise through-holes formed through the thickness of the well plate 192. The pneumatic ports 196 are arranged in a symmetric pattern with respect to the geometric center of the well plate 192 and, in the illustrated embodiment, include twelve (12) pneumatic ports 196 with groups of three ports disposed along, or circumscribing, the perimeter of the well plate 192 along each of the four sides thereof. In other embodiments, a well plate may comprise more or less than twelve (12) pneumatic ports, and the pneumatic ports may be arranged in other, preferably biaxially symmetric shapes, such as a circle or a biaxially symmetric polygon. In various embodiments, the number of pneumatic ports 196 is equal to the number of reagent wells 194, and the arrangements of the ports 196, e.g., square, is the same as the arrangement of the reagent wells 194. In the illustrated embodiment, the pneumatic ports 196 are disposed outwardly from the reagent wells 194 with respect to the geometric center of the well plate 192 and are disposed in close proximity to the peripheral edges of the well plate 192.

Pneumatic ports 196 may be covered, for example with a liquid impervious, gas porous membrane or mesh.

Well plate 192 may be formed from cyclic olefin copolymer (COC) which has high temperature resistance. Other suitable materials include polycarbonate or Cyclic Olefin Polymer (COP) available from ZEON Chemicals. COC and COP provide a high transparency in the visible range, good moldability, low fluorescence, good chemical resistance, and high heat resistance.

In the illustrated embodiment, the chip 190 and the well plate 192, the microchannel plate 200, and the PCB 220, are square in shape, but other, preferably biaxially symmetric shapes may be used, such as a circle or a biaxially symmetric polygon.

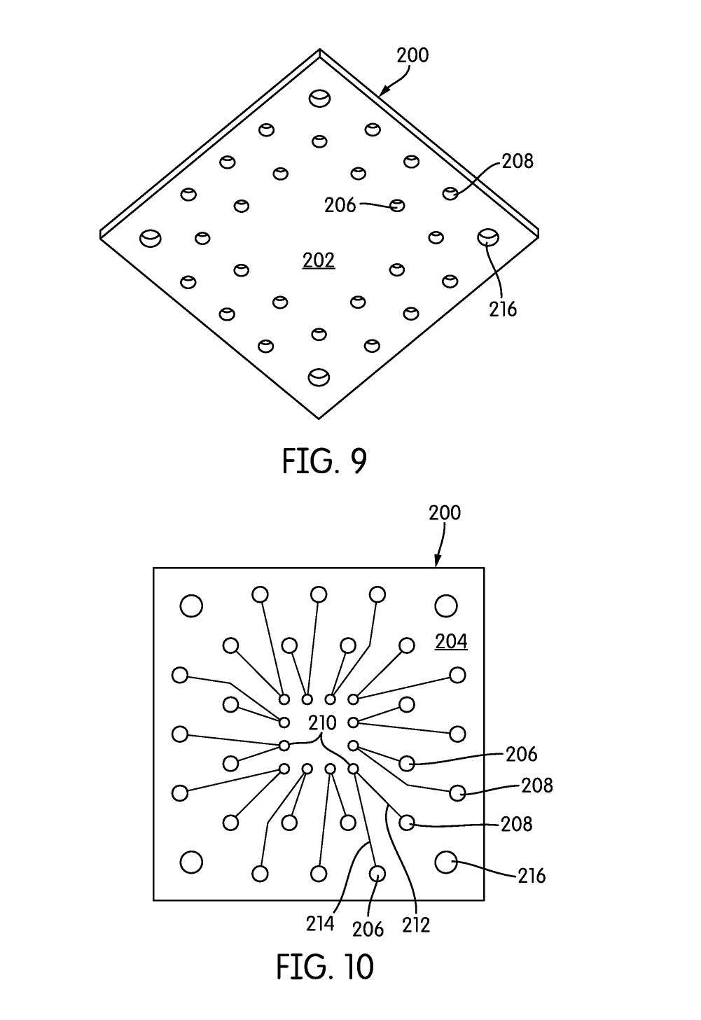

Referring to FIGS. 7-10, the microchannel plate, or second plate, 200 includes a first or top surface 202 and a second or bottom surface 204. A plurality of well through-holes 206 extend through the microchannel plate 200 at locations corresponding to the locations of the reagent wells 194 of the well plate secured to the top surface 202 of the microchannel plate 200. Similarly, a plurality of pneumatic port through-holes 208 extend through the microchannel plate 200 at locations corresponding to the locations of the pneumatic ports 196 of the well plate 192.

A plurality of reaction wells 210 are formed as blind recesses in the second or bottom surface 204 of the microchannel plate 200. The microchannel plate 200 includes twelve (12) reaction wells 210 corresponding in number to the number of reagent wells 194 and pneumatic ports 196. In an exemplary embodiment, the reaction wells are 800 μm across (outside diameter) and are 80 μm tall with a volume of 40 nL. In various embodiments, the reaction wells 210 are arranged in a symmetrical pattern circumscribing the geometric center of the microchannel plate 200. In the illustrated embodiment, the reaction wells 210 are arranged in a square ring pattern. In other embodiments, the reaction wells may be arranged in a different, preferably biaxially symmetric pattern, such as a circular pattern.

Microchannel plate 200 may be formed from cyclic olefin copolymer (COC).

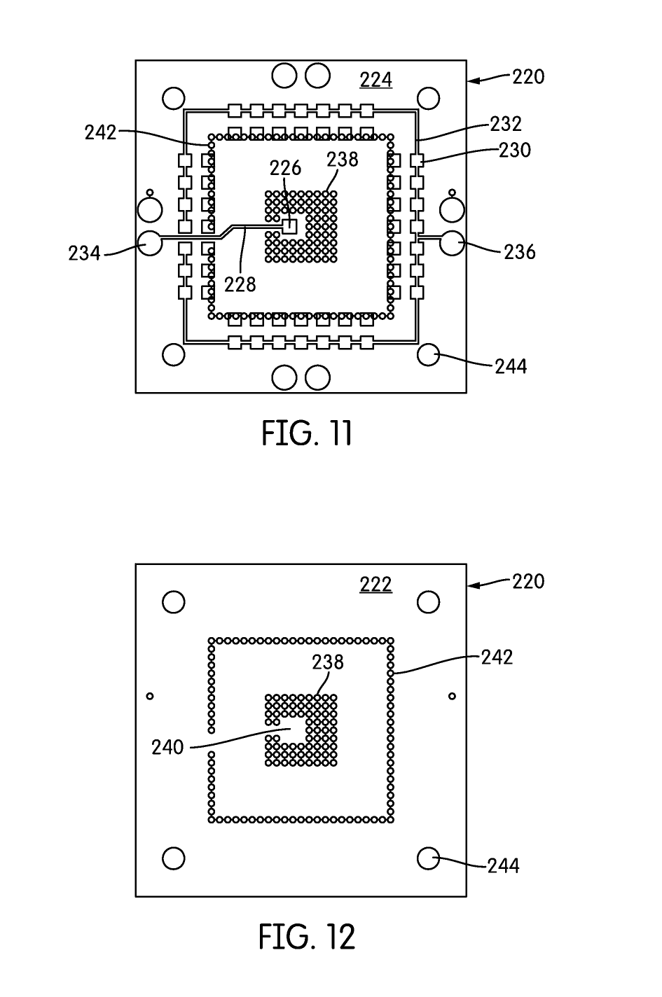

Referring to FIG. 10, which shows a plan view of the bottom surface 204 of the microchannel plate 200, the microchannel plate 200 may include a plurality of first microchannels 212 connecting each of the well through-holes 206 (and the corresponding reagent well 194) to one of the reaction wells 210 and a plurality of second microchannels 214 connecting each of the pneumatic port through-holes 208 (and the corresponding pneumatic ports 196) to the reaction wells 210. The first and second microchannels 212, 214 may be formed as microgrooves formed in the bottom surface 204 of the microchannel plate 200.

In one embodiment, the microchannel plate 200 is made of a transparent material so that optical measurements, such as fluorescent emission measurements made during a PCR and/or a thermal melt process, can be made of a reaction occurring within each of the reaction wells 210 through an opening 198 formed in the well plate 192 at a location corresponding to the location of the reaction wells 210 in the microchannel plate 200.

Referring to FIGS. 11 and 12, the PCB 220 includes a first or top surface 222 (FIG. 12) and a second or bottom surface 224 (FIG. 11). In various embodiments, some or all of the top surface 222 is a flat copper plate (or other suitable thermally conductive material). The PCB 220 is arranged within the microchip 190 with the first or top surface 222 covering at least a portion of the second or bottom surface 204 of the microchannel plate 200.

In various embodiments, the PCB 220 includes a thermal sensor 226 disposed on the bottom surface 224. The thermal sensor 226 may comprise, for example, a platinum 0603 RTD and may comprise one or multiple individual sensors. A sensor connector 228 extends from the sensor 226 to a sensor conductor pad 234 located on the bottom surface 224 and configured to be engaged by a contact connector, e.g., a pogo pin, in a processing instrument.

In an alternate embodiment, thermal sensors may be provided in or adjacent to each reaction well 210 as in the embodiments of FIGS. 2-7.

In various embodiments, the microchannel plate 200 and the PCB 220 have cooperating, alignment holes 216 and 244, respectively.

In various embodiments, the PCB 220 further includes a plurality of heater elements 230, which, for example, may comprise SMT resistors (e.g., 470 ohm) on the bottom surface 224 of the PCB. The heater elements 230 are interconnected by a bus bar 232, which is connected to a heater conductor pad 236 located on the bottom surface 224 and configured to be engaged by a contact connector, e.g. a pogo pin, in a processing instrument. The heater elements 230 are arranged symmetrically about the geometric center of the PCB 220. The PCB 220, the microchannel plate 200, and the well plate 192 share a common geometric center. Thus, the heater elements 230 are also arranged symmetrically with respect to the geometric centers of the microchannel plate 200 and the well plate 192.

Thermal coupling between the top surface 222 and bottom surface 224 of the PCB 220 is achieved by the addition of plated through holes (PTH), filled PTH, blind or buried vias, microvias, thermal vias, etc. In various embodiments, the PCB 220 further includes a plurality of sensor vias 238 extending through the PCB 220 from the bottom surface 224 to the top surface 222 and arranged in a cluster generally surrounding the thermal sensor 226 with an open area 240 that is devoid of sensor vias at which the thermal center 226 is disposed. In various embodiments, the sensor vias 238 are arranged in a cluster or pattern having an area generally corresponding to an area that is circumscribed by the reaction wells 210 of the microchannel plate 200. In the illustrated embodiment, the sensor vias 238 are arranged in a square pattern having dimensions generally corresponding to the square pattern of the reaction wells 210.

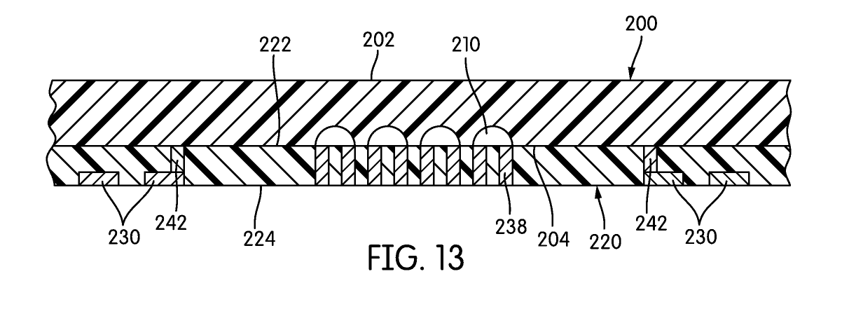

The PCB 220 may further include a plurality of heater vias 242 extending from the heater elements 230 to the top surface 222 and arranged in a symmetric pattern with respect to the geometric center of the PCB 220 so as to surround, or circumscribe, the cluster of sensor vias 238. Referring to FIG. 13, which is a partial cross-section of the PCB 220 with the microchannel plate 200 secured thereto, the heater vias 224 conduct thermal energy from the heater elements 230 to the interface between the top surface 222 of the PCB and the bottom surface 204 of the microchannel plate 200. The heater elements 230 and the corresponding heater vias 242 are configured in a ring pattern circumscribing the reaction wells 210. The symmetrical arrangement of the reaction wells 210 and the heating vias 242 improves thermal uniformity throughout the reaction wells 210.

Thus, the heater elements 230 and associated heater vias 242 are effective to heat the area circumscribed by the heater vias 242, including the reaction wells 210 and the contents thereof.

The sensor vias 238 conduct thermal energy from the interface between the top surface 222 of the PCB 220 and the bottom surface 204 of the microchannel plate 200 to the bottom surface 224 of the PCB 220. The thermal sensor 226 detects the temperature of the cluster of sensor vias 238 at the bottom surface 224 of the PCB 220 which corresponds to the temperature of the reaction wells 210 adjacent to the top surface 222 of the PCB. The sensor vias 238 under the temperature sensor 226 are arranged to form a large landing which promotes uniformity of temperature over a larger area that is disposed beneath the reaction wells

In various embodiments, vias 238 and 242 are made from copper. To promote bonding to the microchannel plate 200, the vias 238, 242 are preferably blind vias that leave the top surface 222 of the PCB 220 a copper plane flat.

A further explanation of the heat transfer mechanisms within the PCB 220 is now provided with reference to FIG. 13.

In various embodiments, a goal is to make the PCB 220 have very anisotropic thermal conductivity. This relies on the fact that materials of which the vias 238, 242 and the top surface 222 of the PCB 220 are constructed, e.g., copper and/or solder, have much higher thermal conductivities than the material of which the substrate of the PCB 220 is made (e.g., fiberglass). Specifically, thermal vias 238, 242 are provided to transfer heat between bottom surface 224 and top surface 222. In addition, pathways of thermal conductivity in a lateral direction are provided by the conductive material of the top surface 222.

This concept exploits the nature of using two very different classes of conductors (good conductors, such as copper and the like, and poor conductors, such as fiberglass) in parallel and series thermal circuits to selectively direct the heat flow through the PCB 220. Thus, heat transfers readily from the heater elements 230 to the top surface 222 via the heater vias 242, but does not transfer readily in a lateral direction from the heater elements 230 to the thermal sensor 226 across the thermally nonconductive lower surface 224 or through the thermally nonconductive substrate of the PCB 220. On the other hand heat transfers readily in a lateral direction from the tops of the heater vias 242 across the top surface 222, at least a portion of which is covered with a conductive material, to the reaction wells 210. Some or all of the areas of the top surface 222 between the outer peripheral edges of the PCB 220 and the tops of the heater vias 242 may not be covered with a conductive material, so as to limit outward lateral heat transfer from the heater vias 242 toward the outer peripheral edges of the PCB 220.

The reaction volumes within the reaction wells 210 are disposed on a thermally conductive portion of the top surface 222 of the PCB 220. Thus, heat transfers readily via the sensor vias 238 from the top surface 222 to the bottom surface 224 on which the thermal sensor 226 is disposed within the open area 240 of the cluster of sensor vias 238. See FIG. 12. In various embodiments, the thermal sensor 226 may also rest on a thermally conductive plane provided over a portion of the bottom surface 224.

Thus, the large differences in the thermal conductivity provided by the vias 238, 242 and thermally conductive portions of the top surface 222 and bottom surface 224 as compared to the substrate of the PCB directs the heat transfer from the heater elements 230, up the heater vias 242, laterally across the top surface 222 to the reaction wells 210, and then down the sensor vias 238 to the thermal sensor 226.

Microfluidic Chip Processing

A procedure for using a microfluidic chip is as follows. The process will be described with reference to the microfluidic chip 120 shown in FIGS. 2 and 3, although a similar or identical process could be performed using any of the microfluidic chips shown in FIG. 4, 5, or 6.

In a first step, a user pierces the foil 138 to dispense sample material to the reagent wells 128. The user may employ a syringe or similar device.

After piercing the foil 138 and dispensing sample into the reagent wells 128, the user covers the reagent wells 128 with a liquid impervious, gas porous membrane, which may be secured to the top surface 124 of the chip 120 above the reagent wells 128 by an adhesive backing or the like.

The microfluidic chip 120 is then placed within a processing instrument, which mixes the contents of the reagent wells 128 by shaking, rotation, oscillation, etc. of the microfluidic chip 120, which mixing can include means requiring beads, magnetic or not, or other similar structures. Alternatively, mixing may be effected by pumping the mixture back and forth through the reaction wells and microchannels.

A pump within the instrument which is in communication with the pneumatic ports 130 applies a vacuum, thereby drawing a mixture of sample and reagent material from each of the reagent wells 128 through the first microchannel 144 into each of the reaction wells 132 and then through the second microchannel 146 to the pneumatic port 130. Constant application of a vacuum holds the sample mixture against the liquid impervious, gas porous mesh, or membrane, 140, thereby holding the sample mixture fixed within the microfluidic chip. As described above, photodiodes or other optical signal detection sensors may be employed to detect a fluorescent emission from each reaction well 132 to thereby confirm the presence or absence of the sample mixture therein.

Next, an amplification procedure is performed by, for example, applying heat to the reaction wells 132 and the contents thereof. Heat may be applied in a thermocyclic manner, for example, for a PCR reaction, or it may be applied in an isothermal manner.

Following the amplification procedure, a thermal melt analysis may be performed by applying heat to the contents of the reaction wells 132.

During the amplification and/or thermal melt process(es) an optical signal detection mechanism, e.g., a photodiode, may be employed for detecting fluorescent or other optical emissions emanating from the contents of the reaction wells 132.

At the conclusion of amplification and/or thermal melt, the instrument pump may apply a positive pressure to the pneumatic ports 130 to thereby push the sample mixture back into the reagent wells 128 so that the contents thereof may be extracted for further processing if desired.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A device for performing a microfluidic procedure, comprising:
a first plate having a plurality of reagent wells and pneumatic ports formed therein;
a second plate having a first surface secured to a surface of the first plate and including a plurality of reaction wells and a plurality of microchannels formed therein, wherein the microchannels are configured to fluidly connect each of said reaction wells to one of said reagent wells and to one of said pneumatic ports; and
a printed circuit board (PCB) having a first surface secured to a second surface of the second plate opposite the first surface of the second plate, wherein said PCB comprises:
one or more heater elements secured to a second surface of the PCB opposite the first surface;
one or more temperature sensors secured to the second surface of the PCB;
one or more thermally conductive vias associated with the heater element(s) and configured to provide a thermal coupling between the heater element(s) and the reaction wells; and
one or more thermally conductive vias associated with the temperature sensor(s) and configured to provide a thermal coupling between the temperature sensor(s) and the reaction wells.

2. The device of claim 1 comprising a plurality of heater elements arranged in a pattern surrounding the reaction wells.

3. The device of claim 1, wherein the temperature sensor(s) is(are) mounted in a via landing beneath the reaction wells.

4. The device of claim 1, wherein at least one of the first and second plates is made from plastic.

5. The device of claim 4, wherein the plastic comprises cyclic olefin copolymer.

6. The device of claim 1, wherein the pneumatic ports are arranged in a pattern circumscribing a perimeter of the first plate and the reagent wells are arranged in a pattern circumscribing a geometric center of the first plate at a location inwardly of the pneumatic ports.

7. The device of claim 1, wherein the first plate, the second plate, and the PCB are rectangular or square.

8. The device of claim 1, wherein the first plate, the second plate, and the PCB are rectangular or square and have the same dimensions.

9. The device of claim 1, wherein the first plate includes an opening formed therein at a location corresponding to a location of the reaction wells in the second plate.

10. The device of claim 1, wherein the thermally conductive vias are formed from copper.

11. The device of claim 1, wherein the reagent wells and the pneumatic ports are arranged symmetrically with respect to a geometric center of the first plate.

12. The device of claim 1, further comprising a pierceable foil covering open top ends of the reagent wells.

13. The device of claim 1, further comprising a liquid impervious, gas porous mesh covering the pneumatic ports.

14. The device of claim 1, wherein each heater element comprises a resistor mounted on the second surface of the PCB.

15. The device of claim 14, further comprising a heater conductor pad electrically connected to the heater elements and located on the second surface of the PCB and configured to make electrically conductive contact with a contact element in a processing instrument.

16. The device of claim 1, wherein the sensor element comprises a resistance temperature detector mounted on the second surface of the PCB.

17. The device of claim 16, further comprising a sensor conductor pad electrically connected to the sensor element and located on the second surface of the PCB and configured to make electrically conductive contact with a contact element in a processing instrument.

18. A device for performing a microfluidic procedure, comprising:
a substrate having a plurality of reagent wells and pneumatic ports formed therein;
a microchannel plate having a first surface secured to a surface of the substrate and including a plurality of reaction wells, a plurality of first microchannels, and a plurality of second microchannels formed therein, wherein each first microchannel is configured to fluidly connect each of said reaction wells to one of said reagent wells and each second microchannel is configured to fluidly connect each of said reaction wells to one of said pneumatic ports; and
a temperature sensor disposed within each reaction well.

19. The device of claim 18, wherein at least one of the substrate and the microchannel plate is made from plastic.

20. The device of claim 19, wherein the plastic comprises cyclic olefin copolymer.

21. The device of claim 18, further comprising a pierceable foil covering open top ends of the reagent wells.

22. The device of claim 18, further comprising a liquid impervious, gas porous mesh covering the pneumatic ports.

23. A method of holding a liquid within a fixed location within a microfluidic device comprising a plurality of sample wells, a plurality of pneumatic ports, each pneumatic port being fluidically connected to one of said input wells, and liquid impervious, gas porous membranes covering the pneumatic ports, said method comprising applying a continuous negative pressure at the pneumatic ports to draw liquid from the input wells to the membrane covering the pneumatic ports, wherein the membrane permits the negative pressure to be applied to the liquid but prevents the liquid from exiting the pneumatic ports through the membrane.

24. The method of claim 23, wherein the microfluidic device further includes a pierceable foil covering the sample wells, the method further comprising:
piercing the foil covering at least one of the reagent wells; and
dispensing liquid sample material into the reagent well through an opening pierced in the foil covering the well.

25. The method of claim 23, further comprising:
drawing the liquid to the membrane covering the pneumatic ports through a microfluidic channel; and
determining if a microfluidic channel has been filled by measuring fluorescent emission from a portion of the channel.

26. A method for adding fluid material to a microfluidic device comprising a plurality of reagent wells covered with a pierceable foil and a plurality of pneumatic ports, each pneumatic port being fluidically connected to one of said input wells, said method comprising:
piercing the foil covering at least one of the reagent wells;
dispensing liquid sample material into the reagent well through an opening pierced in the foil covering the well;
covering each opening pierced in the foil with a liquid impervious, gas porous membrane;
applying a pressure differential at the pneumatic ports to draw liquid from the input well into one or more microfluidic channels connecting the input wells with the pneumatic ports; and
determining if a microfluidic channel has been filled by measuring fluorescent emission from a portion of the channel.

27. The method of claim 26, further comprising mixing the fluid dispensed into the input wells by shaking or rotating the microfluidic device or by pumping liquid back and forth through the microfluidic channels.

28. The method of 26, further comprising performing a nucleic acid amplification process after drawing fluid from the input wells to the microfluidic channels.

29. The method of claim 28, further comprising performing a thermal melt analysis on a product of the nucleic acid amplification.

30. The method of claim 26, further comprising reversing the pressure differential applied at the pneumatic ports to push fluid from the microfluidic channel back to the input well.
